(19) United States
(12) Patent Application Publication
(10) Pub. No.: US 2009/0248740 A1
(43) Pub. Date: Oct. 1, 2009

(54) DATABASE FORM AND REPORT CREATION AND REUSE

(75) Inventors: Michael J. McCormack, Redmond, WA (US); Scott T. Gardner, Redmond, WA (US); Jason A. Bould, Redmond, WA (US); Sumit Chauhan, Redmond, WA (US); David J. Conger, Redmond, WA (US); Robert E. Coggins, Redmond, WA (US); Andrew R. Miller, Redmond, WA (US); Ryan McMinn, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/417,508

(22) Filed: Apr. 2, 2009

Related U.S. Application Data
(63) Continuation-in-part of application No. 11/942,963, filed on Nov. 20, 2007.

(51) Int. Cl. G06F 7/00; G06F 12/00; G06F 12/16

(52) U.S. Cl. 707/103 R; 707/204; 707/E17.055; 711/E12.001; 711/E12.103

(57) ABSTRACT

Embodiments are provided for creating and reusing database forms and reports. A selection of an object may be received from a database by a database software application executing on a computer system. The object may include a form or a report. The application may further receive an input to initiate saving the selected object as a new form template or a new report template. In response to receiving the input, the application may be configured to generate a dialog for receiving the selected object and save the selected object as a new form template or a new report template. Any controls, sub-forms, sub-reports, properties, macros, code, and object model references which may be included in the selected object are persisted in the newly created templates for reuse.

### CROSS-REFERENCE TO RELATED APPLICATIONS

This application is a continuation in part of U.S. patent application Ser. No. 11/942,963, filed on Nov. 20, 2007, and entitled “Database Part Creation, Merge and Reuse,” the disclosure of which is hereby incorporated herein, in its entirety, by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Many database software applications allow the creation and utilization of database templates to facilitate the building of solutions using database data, such as forms and reports. The database software applications provide predefined forms and reports, each having a set of default properties. The properties associated with the predefined forms and reports cannot be modified without technical expertise which may be beyond the knowledge of the typical database user. Thus, typical database users are unable to create forms and reports having properties which are different from the default properties and unable to regularly reuse them. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for creating and reusing database forms and reports. A selection of an object may be received from a database by a database software application executing on a computer system. The object may include a form or a report. The application may further receive an input to initiate saving the selected object as a new form template or a new report template. In response to receiving the input, the application may be configured to generate a dialog for receiving the selected object and save the selected object as a new form template or a new report template. Any controls, sub-forms, sub-reports, properties, macros, code, and object model references which may be included in the selected object are persisted in the newly created templates for reuse.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 shows a block diagram illustrating a computing environment which may be utilized for creating and reusing database forms and reports, in accordance with various embodiments;

FIG. 2 shows a flow diagram illustrating a routine for creating and reusing database forms and reports, in accordance with an embodiment;

FIG. 3 shows a flow diagram illustrating a routine for saving form/report objects as new form/report templates for reuse, in accordance with an embodiment;

FIG. 4A shows a computer screen display of a user interface which may be utilized to initiate the creation of database forms, in accordance with an embodiment;

FIG. 4B shows a computer screen display of a user interface which may be utilized to initiate the creation of database reports, in accordance with an embodiment; and

FIG. 5 shows a computer screen display of a user interface which may be utilized in the creation of database forms and reports for reuse, in accordance with an embodiment.

### DETAILED DESCRIPTION

Embodiments are provided for creating and reusing database forms and reports. A selection of an object may be received from a database by a database software application executing on a computer system. The object may include a form or a report. The application may further receive an input to initiate saving the selected object as a new form template or a new report template. In response to receiving the input, the application may be configured to generate a dialog for receiving the selected object and save the selected object as a new form template or a new report template. Any controls, sub-forms, sub-reports, properties, macros, code, and object model references which may be included in the selected object are persisted in the newly created templates for reuse.

Referring now to the drawings, in which like numerals represent like elements, various illustrative embodiments will now be described.

### Exemplary Operating Environment

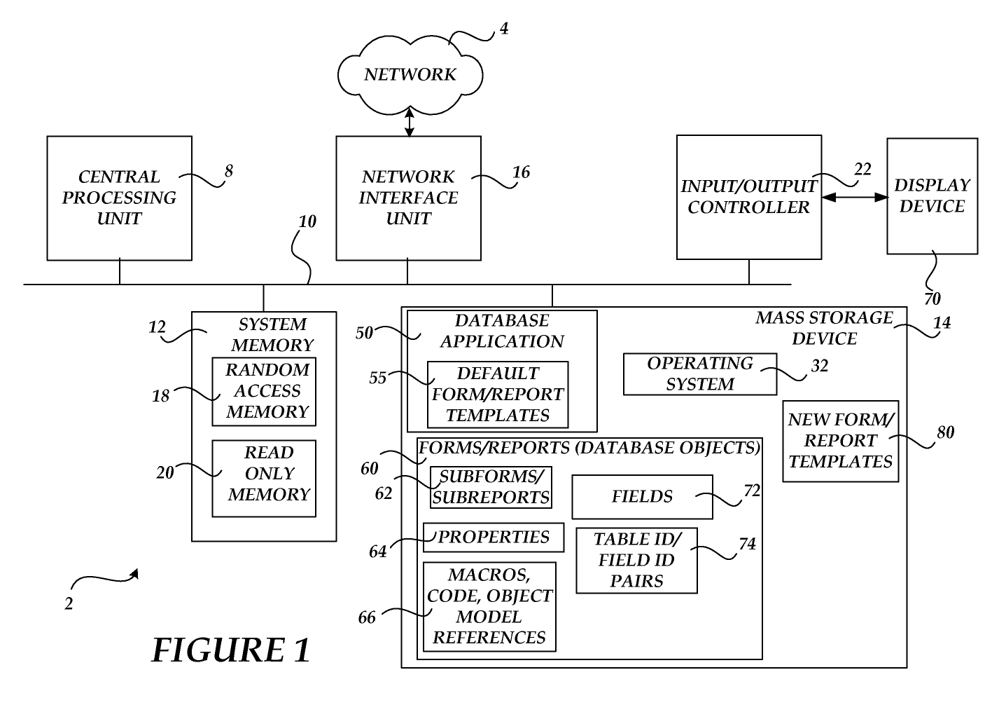

Referring now to FIG. 1, the following discussion is intended to provide a brief, general description of a suitable computing environment in which various illustrative embodiments may be implemented. While various embodiments will be described in the general context of program modules that execute in conjunction with program modules that run on an operating system on a personal computer, those skilled in the art will recognize that the various embodiments may also be implemented in combination with other types of computer systems and program modules.

Generally, program modules include routines, programs, components, data structures, and other types of structures that perform particular tasks or implement particular abstract data types. Moreover, those skilled in the art will appreciate that the various embodiments may be practiced with other computer system configurations, including hand-held devices, multiprocessor systems, microprocessor-based or programmable consumer electronics, minicomputers, mainframe computers, and the like. The various embodiments may also be practiced in distributed computing environments where tasks are performed by remote processing devices that are linked through a communications network. In a distributed computing environment, program modules may be located in both local and remote memory storage devices.

FIG. 1 shows a computer 2 which may include a general purpose desktop, laptop, handheld, tablet, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20.

The computer 2 further includes a mass storage device 14 for storing an operating system 32, a database application 50, a collection of database forms/reports (i.e., database objects) 60, and new form/report templates 80. In accordance with various embodiments, the operating system 32 may be suitable for controlling the operation of a networked personal computer, such as the WINDOWS operating systems from MICROSOFT CORPORATION of Redmond, Wash.

The database application 50 may comprise the ACCESS database creation and management desktop application program, also from MICROSOFT CORPORATION of Redmond, Wash. The database application 50 may include default (i.e., standard) form/report templates 55 which may be used to create forms and reports containing data from various database table fields. The database application 50 may also be configured to create the new form/report templates 80 from the forms/reports 60, as will be described in greater detail herein. In accordance with various embodiments, the form/report templates 55 may include, but are not limited to, basic forms, split forms, and blank forms as well as basic reports, blank reports, letters, and labels. The aforementioned form and report types are well known to those skilled in the art and thus will not be discussed further herein.

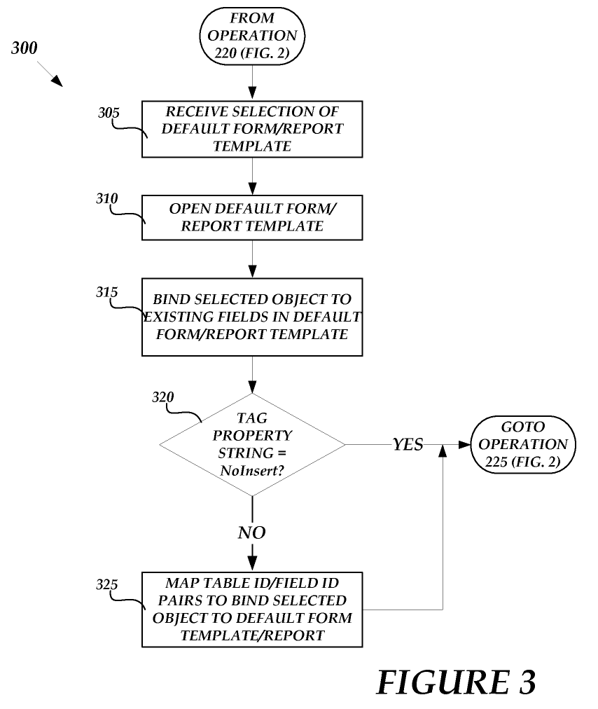

In accordance with an embodiment, the forms/reports 60 may comprise objects representing user-created forms and reports and may further include child controls/objects including, without limitation, sub-forms/sub-reports 62, properties 64, macros, code, and object model references 66, and fields 72, and table ID/field ID pairs 74. In an illustrative embodiment, the forms/reports 60 may include an order form or orders report (for viewing the status of an order) including: a sub-form or sub-report for line items so that every order has a set amount of line items attached to that order, a print property for printing the order form in a user-specified format, a user-specified display property for displaying a user-specified background color and for displaying (or not displaying) horizontal scroll bars, a macro for performing a user-specified action when the order form or order report is opened, program code for associated with a user-interface button for opening another user-specified form in response to clicking on the user-interface button, and an ActiveX (i.e., a component object model) reference to a user-specified web control to enable interaction with the form in an HTML document. The fields 72 may comprise form or report database table fields which are bound to the forms/reports 72 and which store forms/reports data. The table ID/field ID pairs 74 identify the fields 72 and database tables comprising the fields 72. In accordance with an embodiment and as will be discussed in greater detail below with respect to FIG. 3, the database application 50 may be configured to map the table ID/field ID pairs 74 for each of the fields 72 in order to bind a selected form or report object to default form template or form report.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2. By way of example, and not limitation, computer-readable media may comprise computer storage media and communication media.

Computer storage media includes volatile and non-volatile, removable and non-removable hardware storage media implemented in any physical method or technology for the storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, which can be used to store the desired information and which can be accessed by the computer 2. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as a computer program product.

According to various embodiments of the invention, the computer 2 may operate in a networked environment using logical connections to remote computers through a network 4, such as a local network or a wide area network (e.g., the Internet), for example. The computer 2 may connect to the network 4 through a network interface unit 16 connected to the bus 10. It should be appreciated by those skilled in the art that when operating in a networked environment, the computer 2 may be in communication with one or more remote servers hosting a shared database services platform such as the EXCEL/ACCESS SERVICES platform from Microsoft Corporation of Redmond, Wash. It should be appreciated that the network interface unit 16 may also be utilized to connect to other types of networks and remote computing systems. The computer 2 may also include an input/output controller 22 for receiving and processing input from a number of input types, including a keyboard, mouse, pen, stylus, finger, and/or other means. Similarly, an input/output controller 22 may provide output to a display device 70, a printer, or other type of output device. Additionally, a touch screen can serve as an input and an output mechanism.

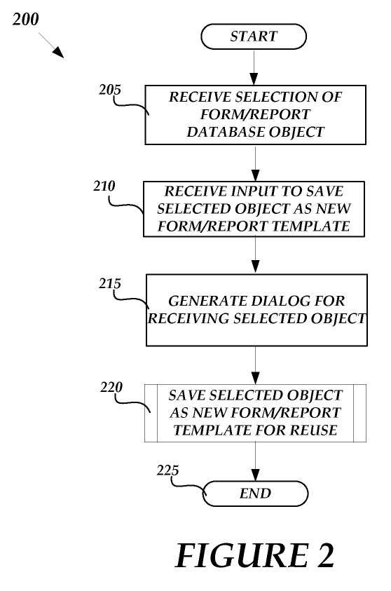

FIG. 2 shows a flow diagram illustrating a routine 200 for creating and reusing database forms and reports, in accordance with an embodiment. The components of FIG. 1 are referred to in the description of FIGS. 2 and 3, but the embodiments are not so limited. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIGS. 2 and 3 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 200 begins at operation 205, where the database application 50 executing on the computer 2 receives a selection of a forms/reports 60 database object. For example, a user may select a previously created order form or report (including any associated sub-forms/sub-reports 62, properties 64, and macros, code, and object model references 66) which has been saved on the mass storage device 14.

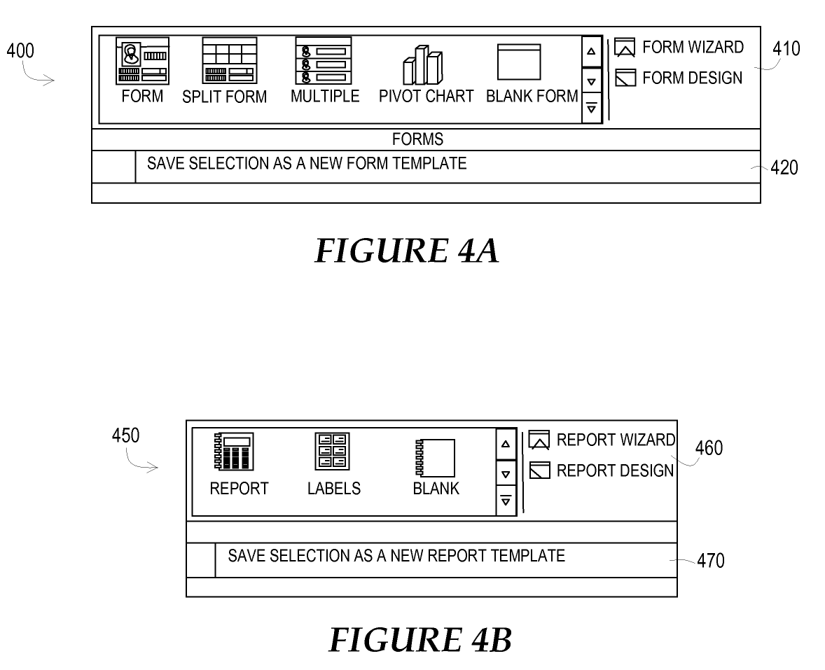

From operation 205, the routine 200 continues to operation 210, where the database application 50 receives an input to initiate the saving of the selected one of the forms/reports 60 as a new form/report template. In particular, after receiving the selection of one of the forms/reports 60, the database application 50 may receive an input in a user interface to initiate the saving of the selected one of the forms/reports 60 as the new template. An illustrative user interface for saving the selected one of the forms/reports 60 as a new template will be described below in the description of FIGS. 4A and 4B.

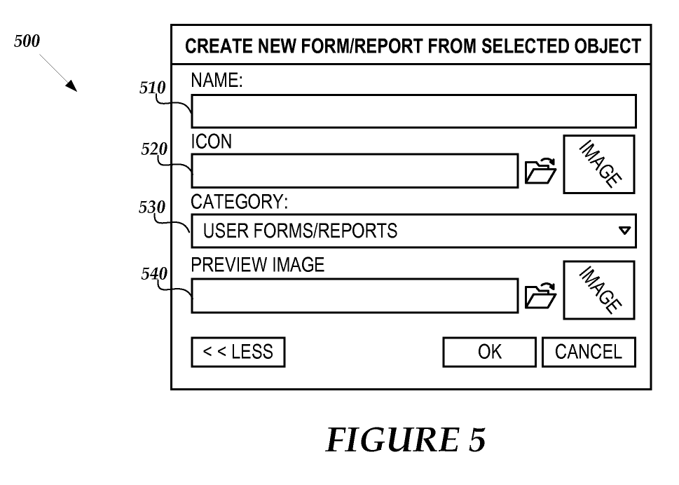

From operation 210, the routine 200 continues to operation 215, where the database application 50 generates a dialog for receiving the selected one of the forms/reports 60 prior to saving it as a new form/report template 80. In particular, the dialog generated by the database application 50 may include descriptive information about the new form/report template 80 including a name, an icon, a category, and a preview image for the new form/report template 80. An illustrative user interface for receiving information about the new form/report template 80 to be created from the selected one of the forms/reports 60 will be described below in the description of FIG. 5.

From operation 215, the routine 200 continues to operation 220, where the database application 50 saves the selected one of the forms/reports 60 as a new form/report template 80. It will be appreciated that any sub-forms/sub-reports 62, properties 64, and macros, code, and object model references 66 in the selected one of the forms/reports 60 will be persisted in the new form/report template 80 and thus may be reused each time the new form/report template 80 is opened by the database application 50 on the computer 2. An illustrative routine for saving form/report objects as new form/report templates for reuse will be described in greater detail below in the discussion of FIG. 3. From operation 220, the routine 200 continues to operation 225 where it ends.

FIG. 3 shows a flow diagram illustrating a routine 300 for saving form/report objects as new form/report templates for reuse, in accordance with an embodiment. The routine 300 begins at operation 305, where the database application 50 executing on the computer 2 receives a selection of one of the default form/report template 55. In particular, a default form/report template 55 may be selected to bind to the one of the forms/reports 60 selected at operation 205 in FIG. 2.

From operation 305, the routine 300 continues to operation 310, where the database application 50 may open the selected default form/report template 55. From operation 310, the routine 300 continues to operation 315, where the database application 50 binds the selected one of the forms/reports 60 (i.e., the selected object) to existing fields in the selected default form/report template 55. It should be understood that if a form or report contains the aforementioned tag property, the database application 50 will not insert any new fields or controls but rather will create a new template following standard naming conditions and then bind the recordsource to the current record source of a currently selected form or report. From operation 320, the routine 300 returns to operation 225 of FIG. 2. It should be understood that, in accordance with various embodiments, “controls” may include ActiveX or similar objects which may be present in a form or report. In particular, controls may include, without limitation, text boxes, labels, buttons, and checkboxes which are displayed in a form or report. It should be further understood that, in accordance with various embodiments, that a “recordsource” is the source of the data used in a form or report, such as a table or query.

From operation 315, the routine 300 continues to operation 320, where the database application determines whether one of the properties 64 for the selected one of the forms/reports 60 includes a “Noinsert” string. In particular, the “NoInsert” string may be a non-localizable string contained within a “tag” property in the properties 64. In accordance with an embodiment, an illustrative tag property for a database form may include the following syntax: application.forms(“templateform”).tag Contains “NoInsert.”

If, at operation 320, the database application 50 determines that the tag property for the selected one of the forms/reports 60 does include a “Noinsert” string, then the routine 300 continues to operation 325 where the database application 50 binds the selected one of the forms/reports 60 (i.e., the selected object) to the selected default form/report template 55 by mapping the table ID/field ID pairs 74. In particular, the database application 50 may be configured to create a new database object which is bound to the recordset of the selected one of the forms/reports 60, by “mapping in” the existing data source from the forms/reports 60 to the selected default form/report template 55. From operation 325, the routine 300 returns to operation 225 of FIG. 2. It should be understood that in accordance with various embodiments, a “recordset” is a group of database records (e.g., a combination of rows and columns) returned from a recordsource. If, at operation 315, the database application 50 determines that the tag property for the selected one of the forms/reports 60 does include a “NoInsert” string, then the routine 300 returns to operation 225 of FIG. 2.

FIG. 4A shows a computer screen display of a user interface 400 which may be utilized to initiate the creation of database forms, in accordance with an embodiment. The user interface 400 includes a gallery 410 of default database forms. The user interface 400 also includes a user interface button 420 to initiate the saving of a selection, from the forms/reports 60, as a new form template.

FIG. 4B shows a computer screen display of a user interface 450 which may be utilized to initiate the creation of database reports, in accordance with an embodiment. The user interface 450 includes a gallery 460 of default database reports. The user interface 450 also includes a user interface button 470 to initiate the saving of a selection, from the forms/reports 60, as a new report template.

FIG. 5 shows a computer screen display of a user interface (i.e., dialog) 500 which may be utilized in the creation of database forms and reports for reuse, in accordance with an embodiment.

The user interface 500 includes a Name text box 510, an Icon text box 520, a Category combo box 530, and a Preview Image text box 540. The Name text box 510 may be utilized by a user of the database application 50 to specify a name of the new form/report template 80 to be created. The Icon text box 520 may be utilized by the database application 50 to display a file location of an icon image selected by a user to represent the new form/report template 80. The Category combo box 530 may be utilized by a user of the database application 50 to select a category (e.g., User Forms/Reports) for the new form/report template 80 to appear in. The Preview Image text box 540 may be utilized by a user of the database application 50 to display a file location of an image file selected by a user to serve as a preview image for the new form/report template 80.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer-implemented method for creating and reusing database forms and reports, comprising:
receiving, by the computer, a selection of an object from a database, the object comprising at least one of a form and a report, the at least one of a form and a report comprising at least one of a plurality of properties associated with the at least one of a form and a report and at least one of a macro, code, and an object model reference associated with the at least one of a form and a report;
receiving an input to save the selected object as at least one of a new form template and a new report template;
in response to receiving the input, generating a dialog for receiving the selected object; and
saving the selected object as the at least one of a new form template and a new report template, wherein the plurality of form controls and the plurality of report objects from the selected object are persisted in the at least one of a new form template and a new report template for reuse.

2. The method of claim 1, wherein saving the selected object as the at least one of a new form template and a new report template comprises saving at least one of a sub-form and a sub-report associated with the at least one of a form and a report.

3. The method of claim 1, wherein saving the selected object as the at least one of a new form template and a new report template comprises saving a plurality of properties associated with the at least one of a form and a report.

4. The method of claim 1, wherein saving the selected object as the at least one of a new form template and a new report template comprises saving at least one of a macro, code, and an object model reference associated with the at least one of a form and a report.

5. The method of claim 1, wherein saving the selected object as the at least one of a new form template and a new report template comprises:
receiving a selection of at least one of a default form template and a report template; and
opening the at least one of an default form template and a report template.

6. The method of claim 5, wherein saving the selected object as the at least one of a new form template and a new report template further comprises binding the selected object to a plurality of existing fields in the at least one of a default form template and a report template to save the selected object as the at least one of a new form template and a new report template.

7. The method of claim 5, wherein saving the selected object as the at least one of a new form template and a new report template further comprises determining whether the selected object comprises a tag property having a NoInsert string and, if not, then inserting and binding a plurality of fields in the selected object to the at least one of a default form template and a report template to save the selected object as the at least one of a new form template and a new report template.

8. The method of claim 7, wherein binding a plurality of fields in the selected object to the at least one of a template form and a template report to save the selected object as the at least one of a new form template and a new report template comprises mapping table ID and field ID pairs for each of the plurality of fields to bind the selected object to the at least one of an default form template and a report.

9. A computer system for creating and reusing database forms and reports, comprising:
a memory for storing executable program code; and
a processor, functionally coupled to the memory, the processor being responsive to computer-executable instructions contained in the program code and operative to:
receive a selection of an object from a database, the object comprising at least one of a form and a report, the at least one of a form and a report comprising at least one of a plurality of properties associated with the at least one of a form and a report and at least one of a macro, code, and an object model reference associated with the at least one of a form and a report;
receive an input to save the selected object as at least one of a new form template and a new report template;
in response to receiving the input, generate a dialog for receiving the selected object; and
save the selected object as the at least one of a new form template and a new report template, wherein the plurality of form controls and the plurality of report objects from the selected object are persisted in the at least one of a new form template and a new report template for reuse.

10. The system of claim 9, wherein the processor in saving the selected object as the at least one of a new form template and a new report template, is operative to save at least one of a sub-form and a sub-report associated with the at least one of a form and a report.

11. The system of claim 9, wherein the processor in saving the selected object as the at least one of a new form template and a new report template, is operative to save the plurality of properties associated with the at least one of a form and a report.

12. The system of claim 9, wherein the processor in saving the selected object as the at least one of a new form template and a new report template, is operative to save the at least one of a macro, code, and an object model reference associated with the at least one of a form and a report.

13. The system of claim 9, wherein the processor in saving the selected object as the at least one of a new form template and a new report template, is operative to:
receive a selection of at least one of an default form template and a report template; and
open the at least one of an default form template and a report template.

14. The system of claim 13, wherein the processor in saving the selected object as the at least one of a new form template and a new report template is further to bind the selected object to a plurality of existing fields in the at least one of a default form template and a report template to save the selected object as the at least one of a new form template and a new report template.

15. The system of claim 13, wherein the processor in saving the selected object as the at least one of a new form template and a new report template is further operative to determine whether the selected object comprises a tag property has a NoInsert string and, if not, then the processor is operative to insert and bind a plurality of fields in the selected object to the at least one of a default form template and a report template to save the selected object as the at least one of a new form template and a new report template.

16. The system of claim 15, wherein the processor in binding a plurality of fields in the selected object to the at least one of a template form and a template report to save the selected object as the at least one of a new form template and a new report template, is further operative to map table ID and field ID pairs for each of the plurality of fields to bind the selected object to the at least one of an default form template and a report.

17. A computer-readable storage medium containing computer executable instructions which, when executed on a computer, will cause the computer to perform a method for creating and reusing database forms and reports, comprising:
receiving a selection of an object from a database, the object comprising at least one of a form and a report, the at least one of a form and a report comprising at least one of a sub-form and a sub-report associated with the at least one of a form and a report, a plurality of properties associated with the at least one of a form and a report and at least one of a macro, code, and an object model reference associated with the at least one of a form and a report;
receiving an input to save the selected object as at least one of a new form template and a new report template;
in response to receiving the input, generating a dialog for receiving the selected object; and
saving the selected object as the at least one of a new form template and a new report template, wherein the plurality of form controls and the plurality of report objects from the selected object are persisted in the at least one of a new form template and a new report template for reuse, and wherein saving the selected object as the at least one of a new form template and a new report template comprises:
receiving a selection of at least one of an default form template and a report template; and
opening the at least one of an default form template and a report template.

18. The computer-readable storage medium of claim 17, wherein saving the selected object as the at least one of a new form template and a new report template further comprises binding the selected object to a plurality of existing fields in the at least one of a default form template and a report template to save the selected object as the at least one of a new form template and a new report template.

19. The computer-readable storage medium of claim 17, wherein saving the selected object as the at least one of a new form template and a new report template further comprises:
determining whether the selected object comprises a tag property having a NoInsert string; and
if not, then inserting and binding a plurality of fields in the selected object to the at least one of a default form template and a report template to save the selected object as the at least one of a new form template and a new report template.

20. The computer-readable storage medium of claim 17, wherein binding a plurality of fields in the selected object to the at least one of a template form and a template report to save the selected object as the at least one of a new form template and a new report template comprises mapping table ID and field ID pairs for each of the plurality of fields to bind the selected object to the at least one of an default form template and a report.
